(19) United States
(12) Patent Application Publication
(10) Pub. No.: US 2013/0147801 A1
(43) Pub. Date: Jun. 13, 2013

(54) ELECTRONIC APPARATUS, METHOD FOR PRODUCING AUGMENTED REALITY IMAGE, AND COMPUTER-READABLE RECORDING MEDIUM

(71) Applicant: Takashi KURINO, Sapporo-shi (JP)

(72) Inventor: Takashi KURINO, Sapporo-shi (JP)

(73) Assignee: SAMSUNG ELECTRONICS CO., LTD., Suwon-si, (KR)

(21) Appl. No.: 13/707,860

(22) Filed: Dec. 7, 2012

(30) Foreign Application Priority Data
Dec. 9, 2011 (JP) 10-2011-269523
Sep. 25, 2012 (KR) 10-2012-0106699

(51) Int. Cl. G06T 17/00

(52) U.S. Cl. CPC G06T 17/00
USPC 345/420

(57) ABSTRACT

An electronic apparatus, a method of producing an augmented reality (AR) image, and a computer-readable recording medium. The electronic apparatus may include: an input unit which receives a stereo image acquired by capturing a subject in separate positions and position information of a CG object; a calculator which divides the stereo image into a plurality of areas and calculates depth values of the areas; a renderer which produces a rendered image of the CG object by using the calculated depth values of the areas and the position information of the CG object; and a synthesizer which synthesizes the rendered image and the stereo image.

### CROSS-REFERENCE TO RELATED APPLICATIONS

This application claims priority under 35 U.S.C. §119(a) from Korean Patent Application No. 10-2012-0106699 filed Sep. 25, 2012, in the Korean Intellectual Property Office and Japanese Patent Application No. 2011-269523 filed Dec. 9, 2011, in the Japan Patent Office, the disclosure of which is incorporated herein by reference in its entirety.

### BACKGROUND OF THE INVENTION

1. Field of the Invention

The present general inventive concept relates to an electronic apparatus, a method of producing an augmented reality (AR) image, and a computer-readable recording medium, and more particularly, to an electronic apparatus which produces an AR image in consideration of previous and subsequent states of a subject and a computer graphic (CG) object, a method of producing the AR image, and a computer-readable recording medium.

2. Description of the Related Art

An augmented reality (AR) refers to a hybrid virtual reality which fuses a reality and a virtual environment by using a technology for overlapping a 3-dimensional (3D) virtual object on a real image.

In detail, an AR technology is to sense a marker included in a real image, calculate a position and a direction of the marker, and synthesize a CG image with the position and direction of the marker to produce an AR image.

However, since a conventional AR technology uses a 2-dimensional (2D) real image, it is difficult to calculate a depth of a subject in the 2D real image. Therefore, according to the conventional AR technology, previous and subsequent states of a subject and a CG image are not determined when the subject of a real image overlaps with the CG image. As a result, the CG image is arranged on the subject to produce an AR image. This example will now be described with reference to FIG. 12.

FIG. 12 is a view illustrating an AR image produced by a conventional AR technology.

Referring to FIG. 12, although a subject is in a position for blocking a CG object, the CG object is arranged on a real image, thereby producing an AR image in which the CG object covers the subject.

A conventional AR technology as described above has a problem in that an AR image giving a contradiction to perspective is produced.

### SUMMARY OF THE INVENTION

Exemplary embodiments address the above and other problems and/or disadvantages as well as other disadvantages not described above. Also, the exemplary embodiments are not limited to overcoming the disadvantages described above, and provide new utilities and features.

The exemplary embodiments provide an electronic apparatus which produces an augmented reality (AR) image in consideration of previous and subsequent states of a subject and a computer graphic (CG) object, a method of producing the AR image, and a computer-readable recording medium.

Additional features and utilities of the present general inventive concept will be set forth in part in the description which follows and, in part, will be obvious from the description, or may be learned by practice of the general inventive concept.

Exemplary embodiments of the present general inventive concept provide an electronic apparatus including: an input unit which receives a stereo image acquired by capturing a subject in separate positions and position information of a CG object; a calculator which divides the stereo image into a plurality of areas and calculates depth values of the areas; a renderer which produces a rendered image of the CG object by using the calculated depth values of the areas and the position information of the CG object; and a synthesizer which synthesizes the rendered image and the stereo image.

The calculator may divide the stereo image into the plurality of areas according to a split & merge method.

The calculator may calculate depth values of separate subjects in the stereo image and allocate the calculated depth values of the subjects to the plurality of areas to calculate the depth values of the areas.

The stereo image may include a marker indicating a position of the CG object. The input unit may receive a position of the marker in the stereo image as the position information of the CG object.

The renderer may compare depths of objects of sides of the CG object arranged in the position of the CG object with depths of the subjects to render the CG object.

The renderer may not perform rendering with respect to an area of the CG object comprising an object having a depth deeper than the depths of the subjects

The renderer may produce a 2-dimensional (2D) rendered image of the CG object.

The synthesizer may synthesize one image of the stereo image and the 2D rendered image to produce a 2D augmented reality (AR) image.

The electronic apparatus may further include a user interface which displays the 2D AR image

Exemplary embodiments of the present general inventive concept also provide a method of producing an AR image. The method may include: receiving a stereo image acquired by capturing a subject in separate positions and position information of a CG object; dividing the stereo image into a plurality of areas and calculating depth values of the areas; producing a rendered image of the CG object by using the calculated depth values of the areas and the position information of the CG object; and synthesizing the rendered image and the stereo image.

The stereo image may be divided into the plurality of areas according to a split & merge method.

Depth values of separated subjects in the stereo image may be calculated, and the calculated depth values of the subjects may be allocated to the plurality of areas to calculate the depth values of the areas.

The stereo image may include a marker indicating a position of the CG object. A position of the marker in the stereo image may be received as the position information of the CG object.

Depths of objects of sides of the CG object arranged in the position of the CG object may be compared with the depths of the subjects to render the CG object in order to produce the rendered image.

Rendering may not be performed with respect to an area of the CG object comprising an object having a depth deeper than the depths of the subjects to produce the rendered image.

A 2D rendered image of the CG object may be produced.

One image of the stereo image and the 2D rendered image may be synthesized to produce a 2D AR image.

The method may further include: displaying the 2D AR image.

Exemplary embodiments of the present general concept also provide a computer-readable recording medium comprising a program for executing the method.

Exemplary embodiments of the present general inventive concept also provide an electronic apparatus comprising: an input unit which receives a stereo image of a subject and position information of a CG object; a calculator which calculates depth values of the stereo image; and a renderer which produces a rendered image of the CG object by using the calculated depth values and the position information of the CG object.

In an exemplary embodiment, the electronic apparatus further includes a synthesizer which arranges the rendered CG object at a marker location of the calculated depth values to produce an augmented reality (AR) image.

In an exemplary embodiment, the depth values of the stereo image are calculated by calculating depth values of separated subjects of the stereo image and allocating the depth values of the subjects to a plurality of divided areas.

In an exemplary embodiment, the calculator calculates an overlapping area between the CG object and the subjects based on calculated depth information of the subjects.

In an exemplary embodiment, the renderer produces the rendered image of the CG object by rendering with respect to the CG object while not performing rendering with respect with respect to the calculated overlapping area.

Exemplary embodiments of the present general inventive concept also provide a method of producing an AR image, the method comprising: receiving a stereo image of a subject and position information of a CG object; calculating depth values of a plurality of areas of the stereo image; and producing a rendered image of the CG object by using the calculated depth values and the position information of the CG object.

In an exemplary embodiment, the calculating operation calculates an overlapping area between the CG object and the plurality of areas based on the calculated depth values of the plurality of areas.

In an exemplary embodiment, the method further comprises synthesizing the rendered image and the stereo image by arranging the rendered CG object at a marker location of the calculated depth values to produce an augmented reality (AR) image.

### BRIEF DESCRIPTION OF THE DRAWINGS

These and/or other features and utilities of the present general inventive concept will become apparent and more readily appreciated from the following description of the embodiments, taken in conjunction with the accompanying drawings of which:

FIG. 1 is a block diagram of an electronic apparatus according to an exemplary embodiment of the present general inventive concept;

FIG. 2 is a view illustrating marker images according to an exemplary embodiment of the present general inventive concept;

FIG. 3 is a view illustrating an input image according to an exemplary embodiment of the present general inventive concept;

FIG. 4 is a view illustrating an operation of calculating a depth according to an exemplary embodiment of the present general inventive concept;

FIG. 5 is a view illustrating an operation of dividing an area;

FIGS. 6 and 7 are views illustrating an operation of allocating depth values to a plurality of divided areas;

FIG. 8 is a view illustrating an operation of rendering a computer graphic (CG) object according to an exemplary embodiment of the present general inventive concept;

FIG. 9 is a view illustrating a rendered image according to an exemplary embodiment of the present general inventive concept;

FIG. 10 is a view illustrating a produced augmented reality (AR) image according to an exemplary embodiment of the present general inventive concept;

FIG. 11 is a flowchart illustrating a method of producing an AR image according to an exemplary embodiment of the present general inventive concept; and

FIG. 12 is a view illustrating an AR image produced by a conventional AR technology.

### DETAILED DESCRIPTION OF THE PREFERRED EMBODIMENTS

Exemplary embodiments are described in greater detail with reference to the accompanying drawings.

In the following description, the same drawing reference numerals are used for the same elements even in different drawings. The matters defined in the description, such as detailed construction and elements, are provided to assist in a comprehensive understanding of the exemplary embodiments. Thus, it is apparent that the exemplary embodiments can be carried out without those specifically defined matters. Also, well-known functions or constructions are not described in detail since they would obscure the exemplary embodiments with unnecessary detail.

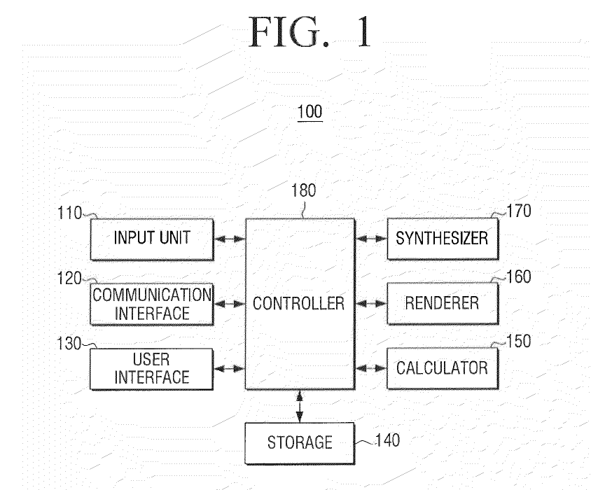

FIG. 1 is a block diagram of an electronic apparatus 100 according to an exemplary embodiment of the present general inventive concept.

Referring to FIG. 1, the electronic apparatus 100 according to the present exemplary embodiment includes an input unit 110, a communication interface 120, a user interface 130, a storage 140, a calculator 150, a renderer 160, a synthesizer 170, and a controller 180. The electronic apparatus 100 according to the present exemplary embodiment may be a PC, a notebook computer, a digital camera, a camcorder, a mobile phone, or the like.

The input unit 110 receives a stereo image acquired by capturing a subject in separate positions. In detail, the input unit 110 may receive a stereo image captured by an imaging device such as an external digital camera or an image reading apparatus (or a scanner). Alternatively, the input unit 110 may form a stereo image by using an imaging device thereof. Here, the stereo image includes left and right images which are formed by capturing the same place in separate positions.

The input unit 110 receives a computer graphic (CG) object which is to be synthesized. In detail, the input unit 110 receives the CG object from an external device (not shown). The CG object is received from the external device in the present exemplary embodiment, but may be pre-stored in the storage 140 which will be described later.

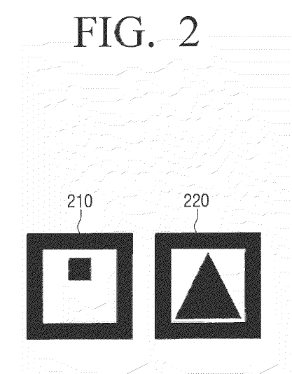

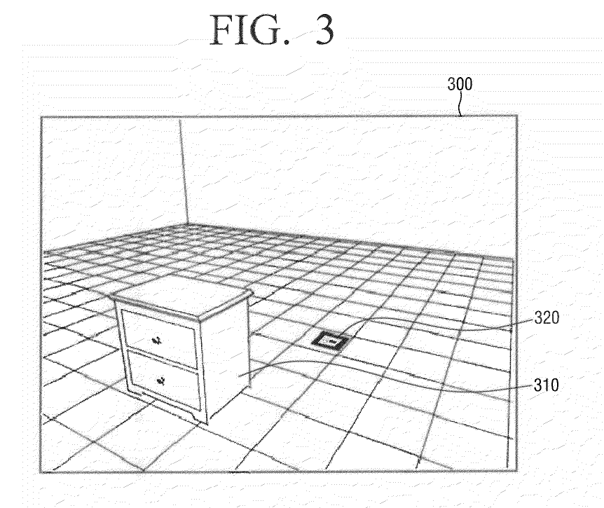

The input unit 110 receives position information of the CG object. The position information is received from an external source in the present exemplary embodiment, but a coordinate value of the CG object may be received through the user interface 130 which will be described later, and the position information of the CG object may be received by using the stereo image including a marker. This example will be described later with reference to FIGS. 2 and 3.

The communication interface 120 is formed to connect the electronic apparatus 100 to the external device and may be connected to a terminal apparatus in a wire or wireless method through a local area network (LAN) and the Internet or through a universal serial bus (USB) port and a Bluetooth module.

The communication interface 120 transmits an augmented reality (AR) image, which is produced by the synthesizer 170 which will be describe later, to the external device. The input unit 110 and the communication interface 120 are illustrated as being separately installed in the present exemplary embodiment, but may be realized together as one element.

The user interface 130 includes a plurality of functional keys through which a user sets or selects various functions supported by the electronic apparatus 100, and displays various types of information provided from the electronic apparatus 100. The user interface 130 may be realized as a device which simultaneously realizes an input and an output, such as, for example, a touch screen. Alternatively, an input device such as a plurality of buttons may be combined with a display apparatus such as a liquid crystal display (LCD) monitor, an organic light-emitting diode (OLED) monitor, or the like in order to realize the user interface 130.

The user interface 130 receives the position information of the CG object. The user interface 130 also displays the AR image produced by the synthesizer 170.

The storage 140 stores the input stereo image. The storage 140 also stores the CG object. The storage 140 stores the AR image produced by the synthesizer 170.

The storage 140 stores a depth and an overlapping area of a subject calculated by the calculator 150, which will be described later, and the CG object rendered by the renderer 160.

The storage 140 may be realized as a storage medium installed in the electronic apparatus 100 or an external storage medium, e.g., a removable disk including a USB memory, a flash memory, etc., a storage medium connected to an imaging device, a web server through a network, or the like.

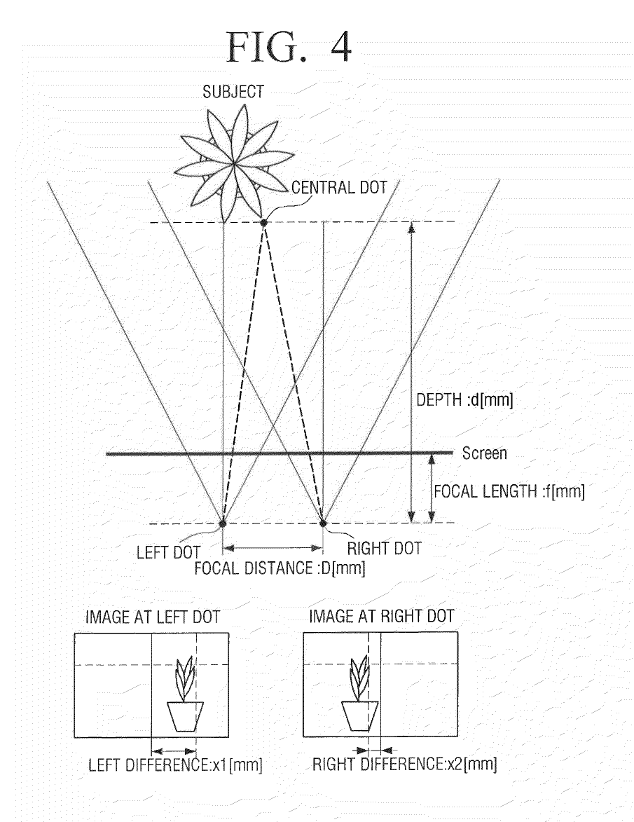

The calculator 150 calculates the depth of the subject by using the input stereo image. In detail, the calculator 150 calculates depth values of separated subjects of the stereo image and allocates the depth values of the subjects to a plurality of divided areas to calculate depth values of the divided areas. Here, the calculator 150 divides the input stereo image into the plurality of areas according to a split & merge method. An operation of calculating depth values of the plurality of areas will be described later with reference to FIGS. 4 through 7.

The calculator 150 calculates an overlapping area between the CG object and the subjects based on calculated depth information of the subjects. In detail, the calculator 150 calculates a depth value of the CG object, calculates a 2-dimensional (2D) coordinate area in which the CG object is to be arranged, senses a subject having a lower depth than the CG object in the 2D coordinate area, and calculates an overlapping area between the sensed subject and the 2D coordinate area.

The renderer 160 produces a rendered image of the CG object except the calculated overlapping area. In detail, the renderer 160 performs rendering with respect to the CG object and does not perform rendering with respect to an overlapping area calculated in a rendering process. The rendered image may be a 2D rendered image or a 3D image rendered image. If the 3D rendered image is produced, and a final AR image is a 2D image, the renderer 160 may convert the 3D rendered image into a 2D rendered image.

In the present exemplary embodiment, the calculator 150 calculates an overlapping area in which rendering is not to be performed, and rendering is performed by using the calculated overlapping area. However, this process may be simultaneously performed with a rendering process.

In detail, the renderer 160 produces the rendered image of the CG object by using the calculated depth values of the areas and the position information of the CG object. In more detail, depths of objects of sides of the CG object arranged in a position of the CG object may be compared with a depth of the subject. If the depths of the objects are deeper than the depth of the subject, rendering may not be performed with respect to the objects. If the depths of the objects are not deeper than the depth of the subject, rendering may be performed with respect to the objects.

The synthesizer 170 synthesizes the rendered image and the stereo image. In detail, the synthesizer 170 selects one image of the stereo image and arranges a rendered CG object in an input CG object position of the selected one image to produce an AR image. If the stereo image includes a marker, the synthesizer 170 arranges the rendered CG object on the marker of the stereo image to produce the AR image.

The controller 180 controls elements of the electronic apparatus 100. In detail, if the stereo image and the CG object are input through the input unit 110, the controller 180 controls the calculator 150 to calculate a depth of each subject of the stereo image, divide the stereo image into the plurality of areas, and calculate depth values of the areas by using the calculated depth values of the subjects.

The controller 180 also controls the renderer 160 to produce a rendered image of the CG object by using the depth values of the areas and the position information of the CG object and controls the synthesizer 170 to synthesize the produced CG rendered image and the stereo image.

If the AR image is produced, the controller 180 controls the user interface 130 to display the produced AR image or controls the communication interface 120 to transmit the produced AR image to the external device.

As described above, the electronic apparatus 100 according to the present exemplary embodiment determines a depth of a subject by using a stereo image and produces an AR image according to the determined depth. Therefore, the electronic apparatus 100 produces the AR image which does not give a contradiction to perspective.

FIG. 2 is a view illustrating marker images according to an exemplary embodiment of the present general inventive concept. FIG. 3 is a view illustrating an input image according to an exemplary embodiment of the present general inventive concept.

Referring to FIG. 2, markers 210 and 220 according to the present exemplary embodiment have preset shapes. Markers having two types of shapes are illustrated in the present exemplary embodiment, but may also have other types of shapes.

Markers as described above may be placed in real environments, and images acquired by capturing the markers are as shown in FIG. 3.

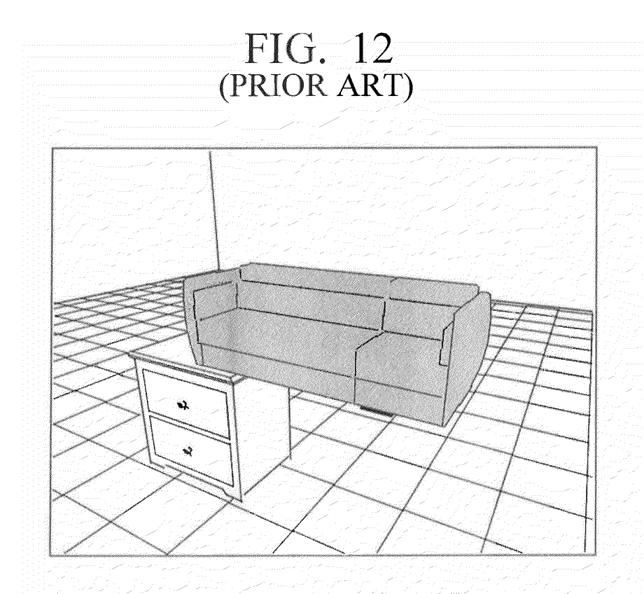

Referring to FIG. 3, a marker is placed in back of a table. According to a conventional technology, an AR image is produced by using a 2D image as shown in FIG. 3. In this case, the produced AR image is as shown in FIG. 12. In other words, a depth of a subject of the 2D image is not calculated. In contrast, an operation of calculating a depth of a subject by using a stereo image is performed in the present exemplary embodiment. This operation will now be described with reference to FIGS. 4 through 7.

FIG. 4 is a view illustrating an operation of calculating a depth according to an exemplary embodiment of the present general inventive concept.

Referring to FIG. 4, a stereo image refers to an image which is acquired by capturing the same place (a central dot) in separate positions (a focal distance). Since the same place is captured in the separate positions, a position of a subject in a left image is different from a position of the subject in a right image.

A depth of the subject in the stereo image is calculated by using the above-described point. In detail, the depth of the subject is calculated by using Equation 1 below:

$$d = D \frac{f}{x 1 + x 2} \qquad ( 1 )$$

wherein d denotes the depth of the subject, D denotes the focal distance, f denotes a focal length, x1 denotes a difference in the left image, and x2 denotes a difference in the right image.

The electronic apparatus 100 calculates depth values of characteristic dots (e.g. subjects) of the stereo image by using the Equation 1 as mentioned above. Since the calculated depth values are only some places in the stereo image, an operation of calculating a depth value of each area in the stereo image is performed.

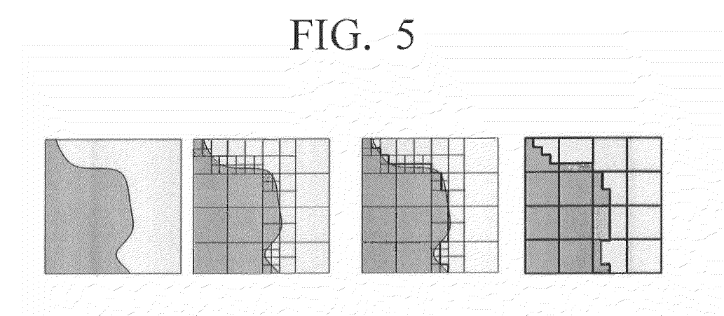

As shown in FIG. 5, a stereo image is divided into a plurality of images. In detail, FIG. 5 illustrates an operation of dividing the stereo image into the plurality of areas by using a split & merge method.

According to the split & merge method, a whole area is recognized as one, and a determination is made as to whether the corresponding area satisfies a similarity measurement. If the corresponding area satisfies the similarity measurement, the whole area is recognized as one area. If the corresponding area does not satisfy the similarity measurement, the corresponding area is sub-divided (in general, the corresponding area is divided into four uniform areas). A determination is made as to whether the areas satisfy the similarity measurement, and the above-described operation is repeatedly performed.

However, if only a split operation is used, an area is too much sub-divided, and thus processing efficiency is lowered. In order to prevent this point, similarities between child areas are compared after the split operation. If the child areas are similar to each other, an operation of merging the child areas is performed. An image is divided into a plurality of areas having similarities.

If a stereo image is divided into a plurality of areas according to the above-described process, depth values of the areas are calculated.

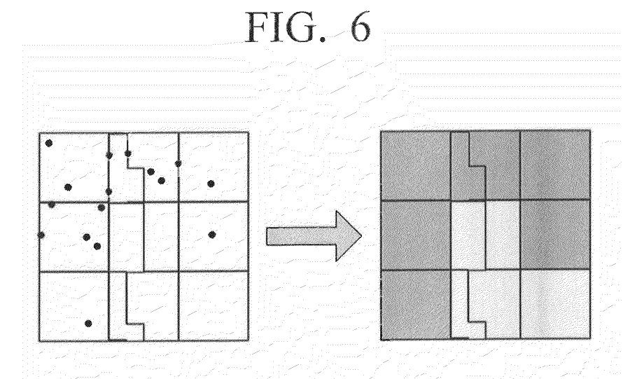

A corresponding dot whose depth value has been calculated in the stereo image is allocated to the image. A result of this process is as in a left image of FIG. 6.

If a plurality of corresponding dots exist in one of areas divided by a process as shown in FIG. 5, an average value of depth values of the plurality of corresponding dots in the one image is calculated and then is set to a depth value of the corresponding area. A result of this process is as in a right image of FIG. 6. An area to which a depth value is allocated is expressed with a dark gray in the right image of FIG. 6, and an area to which a depth value is not allocated is expressed with a bright gray.

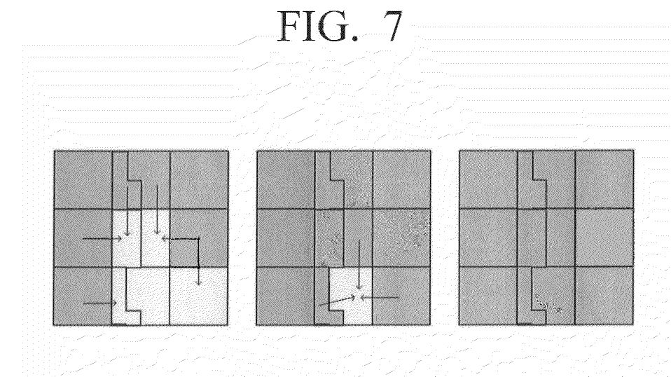

If corresponding dots do not exist in the divided area, an average of depth values of areas adjacent to one another above and below and from side to side is set to a depth value of the corresponding area. Previous operations are repeated until depth values of all areas are allocated. This process is illustrated in FIG. 7.

Depth values of all areas in a stereo image may be calculated according to this process.

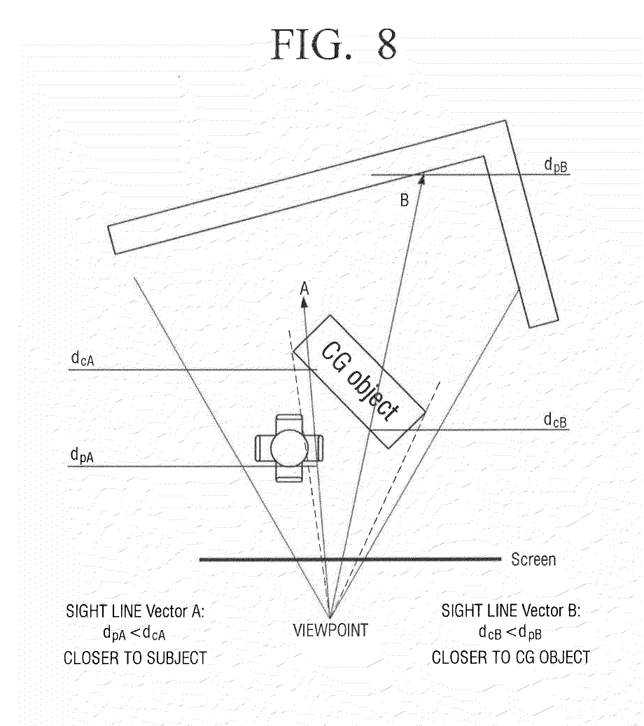

FIG. 8 is a view illustrating an operation of rendering a CG object according to an exemplary embodiment of the present general inventive concept.

Referring to FIG. 8, a position of the CG object is determined as a starting point of a local coordinate to render the CG object. Here, depths of all objects of sides of the CG object are compared with a depth of a subject.

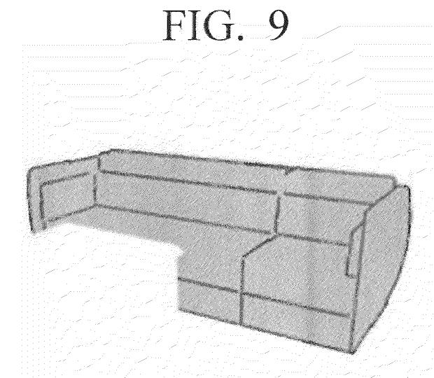

For example, since a sight line vector A of FIG. 8 is closer to the subject than to the CG object, rendering is not performed. Since a sight line vector B is more distant from the subject than from the CG object, rendering is performed. This processing is performed with respect to all pixels to produce a rendered image of the CG object in which a shield area exists due to a subject. The rendered image produced by this processing is as shown in FIG. 9. Referring to FIG. 9, rendering is not performed with respect to a CG object area arranged deeper than a subject.

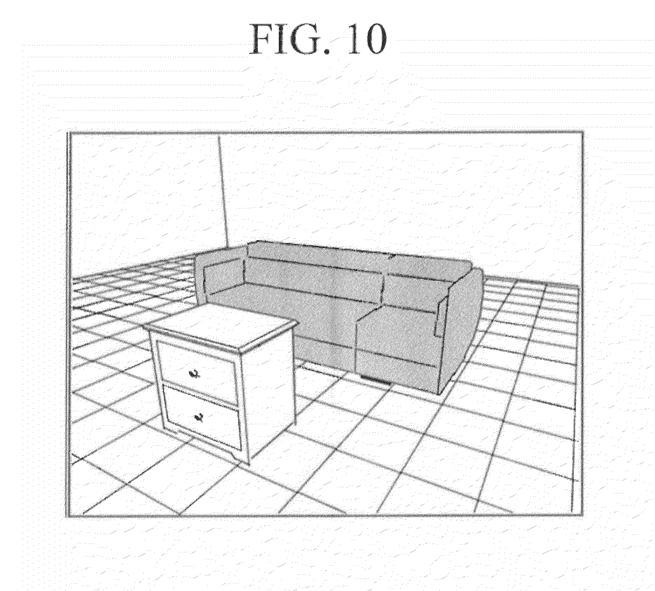

FIG. 10 is a view illustrating a produced AR image according to an exemplary embodiment of the present general inventive concept.

Referring to FIG. 10, an area of the produced AR image arranged in the back of a subject of a CG object is shielded.

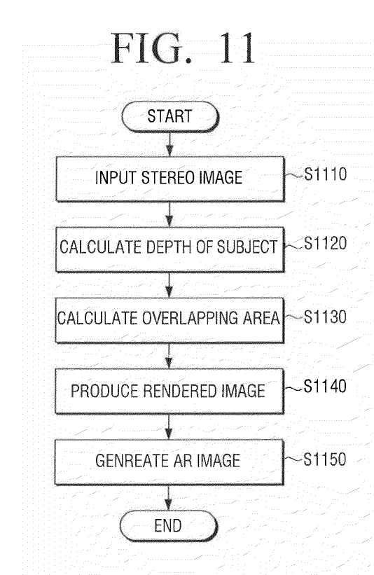

FIG. 11 is a flowchart illustrating a method of producing an AR image according to an exemplary embodiment of the present general inventive concept.

In operation S1110, a stereo image acquired by capturing a subject in separate positions is input. Here, if a CG object is not pre-stored, a CG object to be synthesized may be input. If the stereo image does not include a marker, position information of the CG object may be input.

In operation S1120, depth values of areas in the stereo image are calculated. The operation of calculating the depth values is as described with reference to FIGS. 4 through 7, and thus a repeated description will be omitted herein.

In operation S1130, a rendered image of the CG object is produced based on the calculated depth values and the position of the CG object. A detailed operation of rendering the CG object is as described with reference to FIG. 8, and thus a repeated description will be omitted herein.

In operation S1140, the rendered image of the CG object and the stereo image are synthesized to produce an AR image. Thereafter, an operation of displaying the produced AR image or transmitting the produced AR image to an external device may be performed.

According to the method of producing the AR image according to the present exemplary embodiment, a depth of a subject is determined by using a stereo image, and an AR image is produced according to the determined depth. Therefore, the produced AR image does not give a contradiction to perspective. The method of FIG. 11 may be performed on an electronic apparatus having the structure of FIG. 1 or on electronic apparatus having other types of structures.

Also, the method of producing the AR image as described above may be realized as at least one execution program which is to execute the method, and the execution program may be stored on a computer-readable recording medium.

Accordingly, blocks of the present general inventive concept may be executed as computer-recordable codes on a computer-readable recording medium. The computer-readable recording medium may be a device which stores data readable by a computer system.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An electronic apparatus comprising:
an input unit which receives a stereo image acquired by capturing a subject in separate positions and position information of a CG object;
a calculator which divides the stereo image into a plurality of areas and calculates depth values of the areas;
a renderer which produces a rendered image of the CG object by using the calculated depth values of the areas and the position information of the CG object; and
a synthesizer which synthesizes the rendered image and the stereo image.

2. The electronic apparatus of claim 1, wherein the calculator divides the stereo image into the plurality of areas according to a split & merge method.

3. The electronic apparatus of claim 1, wherein the calculator calculates depth values of separate subjects in the stereo image and allocates the calculated depth values of the subjects to the plurality of areas to calculate the depth values of the areas.

4. The electronic apparatus of claim 1, wherein the stereo image comprises a marker indicating a position of the CG object,
wherein the input unit receives a position of the marker in the stereo image as the position information of the CG object.

5. The electronic apparatus of claim 1, wherein the renderer compares depths of objects of sides of the CG object arranged in the position of the CG object with depths of the subjects to render the CG object.

6. The electronic apparatus of claim 5, wherein the renderer does not perform rendering with respect to an area of the CG object comprising an object having a depth deeper than the depths of the subjects.

7. The electronic apparatus of claim 1, wherein the renderer produces a 2-dimensional (2D) rendered image of the CG object.

8. The electronic apparatus of claim 7 wherein the synthesizer synthesizes one image of the stereo image and the 2D rendered image to produce a 2D augmented reality (AR) image.

9. The electronic apparatus of claim 1, further comprising:
a user interface which displays the 2D AR image.

10. A method of producing an AR image, the method comprising:
receiving a stereo image acquired by capturing a subject in separate positions and position information of a CG object;
dividing the stereo image into a plurality of areas and calculating depth values of the areas;
producing a rendered image of the CG object by using the calculated depth values of the areas and the position information of the CG object; and
synthesizing the rendered image and the stereo image.

11. The method of claim 10, wherein the stereo image is divided into the plurality of areas according to a split & merge method.

12. The method of claim 10, wherein depth values of separated subjects in the stereo image are calculated, and the calculated depth values of the subjects are allocated to the plurality of areas to calculate the depth values of the areas.

13. The method of claim 10 wherein the stereo image comprises a marker indicating a position of the CG object,
wherein a position of the marker in the stereo image is received as the position information of the CG object.

14. The method of claim 10, wherein depths of objects of sides of the CG object arranged in the position of the CG object are compared with the depths of the subjects to render the CG object in order to produce the rendered image.

15. The method of claim 14, wherein rendering is not performed with respect to an area of the CG object comprising an object having a depth deeper than the depths of the subjects to produce the rendered image.

16. The method of claim 10, wherein a 2D rendered image of the CG object is produced.

17. The method of claim 16, wherein one image of the stereo image and the 2D rendered image are synthesized to produce a 2D AR image.

18. The method of claim 10, further comprising:
displaying the 2D AR image.

19. A computer-readable recording medium comprising a program to execute the method of producing an augmented reality (AR) image, the method comprising:
receiving a stereo image acquired by capturing a subject in separate positions and position information of a CG object;
dividing the stereo image into a plurality of areas and calculating depth values of the areas;
producing a rendered image of the CG object by using the calculated depth values of the areas and the position information of the CG object; and
synthesizing the rendered image and the stereo image.

20. An electronic apparatus comprising:
an input unit which receives a stereo image of a subject and position information of a CG object;
a calculator which calculates depth values of the stereo image; and
a renderer which produces a rendered image of the CG object by using the calculated depth values and the position information of the CG object.
